(19) United States
(12) Patent Application Publication
(10) Pub. No.: US 2026/0122795 A1
(43) Pub. Date: Apr. 30, 2026

(54) TAMPER DETECTION ASSEMBLY

(71) Applicant: TE Connectivity Solutions GmbH, Schaffhausen (CH)

(72) Inventors: Kenneth Jermstad, Hampton, VA (US); Michael Ritchie, Hampton, VA (US); Jodi Matzeder, Hampton, VA (US); Jeffrey Creak, Hampton, VA (US); Christopher Larocque, Hampton, VA (US); Julianna Padre, Hampton, VA (US)

(73) Assignee: TE Connectivity Solutions GmbH, Schaffhausen (CH)

(21) Appl. No.: 18/986,881

(22) Filed: Dec. 19, 2024

Related U.S. Application Data
(60) Provisional application No. 63/711,227, filed on Oct. 24, 2024.

(51) Int. Cl. H05K 5/02; G06F 21/86

(52) U.S. Cl. CPC H05K 5/0208; G06F 21/86

(57) ABSTRACT

A tamper detection assembly includes a first body having a plurality of first electrical elements and a second body having a plurality of second electrical elements. The first body and the second body are assembled to enclose a protective volume in an assembled state. The first electrical elements are electrically connected to the second electrical elements to form a tamper circuit that is continuous in the first body and the second body in the assembled state. The first body and the second body are separable in whole from the assembled state into a disassembled state in which the tamper circuit is interrupted.

### CROSS-REFERENCE TO RELATED APPLICATION

This application claims priority under 35 U.S.C. § 119 to U.S. Provisional Ser. No. 63/711,227, filed on Oct. 24, 2024.

### FIELD OF THE INVENTION

The present invention relates to a tamper detection assembly and, more particularly, to a tamper detection assembly of multiple bodies that enclose a protective volume.

### BACKGROUND OF THE INVENTION

A tamper detection assembly commonly includes a tamper detection sensor that is attached to a printed circuit board to enclose a protective volume. Protected digital information is stored on a memory that is contained within the protective volume. The tamper detection sensor and the printed circuit board each have a separate circuit that is connected to a controller in the protective volume, which detects tampering by interruption of either of the circuits.

The tamper detection sensor is typically attached to the printed circuit board with an adhesive. The adhesive is designed to be sufficiently strong that, on any attempts to gain access to the protective volume by separating the printed circuit board and the tamper detection sensor, the adhesive causes the printed circuit board and/or the tamper detection sensor to physically break into multiple pieces, mechanically interrupting the circuit(s) and alerting the controller to the tampering. Although the adhesive and mechanical damage detects the intrusion into the protective volume, it impairs the useful life of the tamper detection assembly and increases waste by not allowing a user to disassemble and service or replace components of the tamper detection assembly without causing permanent damage.

### SUMMARY OF THE INVENTION

A tamper detection assembly includes a first body having a plurality of first electrical elements and a second body having a plurality of second electrical elements. The first body and the second body are assembled to enclose a protective volume in an assembled state. The first electrical elements are electrically connected to the second electrical elements to form a tamper circuit that is continuous in the first body and the second body in the assembled state. The first body and the second body are separable in whole from the assembled state into a disassembled state in which the tamper circuit is interrupted.

### BRIEF DESCRIPTION OF THE DRAWINGS

The invention will now be described by way of example with reference to the accompanying Figures, of which:

FIG. 1 is a perspective view of a tamper detection assembly according to an embodiment;

FIG. 2 is a perspective view of a first body of the tamper detection assembly;

FIG. 3 is a perspective view of a housing of the first body;

FIG. 4 is a sectional perspective view of the tamper detection assembly;

FIG. 5 is a detail view of a portion 5 of FIG. 4;

FIG. 6 is a block diagram of a tamper circuit and a tamper controller of the tamper detection assembly;

FIG. 7A is a schematic diagram of an arrangement of pads in the first body according to an embodiment;

FIG. 7B is a schematic diagram of an arrangement of the pads according to another embodiment;

FIG. 7C is a schematic diagram of an arrangement of the pads according to a further embodiment;

FIG. 7D is a schematic diagram of an arrangement of the pads according to an additional embodiment;

FIG. 8 is a schematic sectional side view of a tamper detection assembly according to another embodiment; and

FIG. 9 is a schematic sectional side view of a tamper detection assembly according to a further embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “vertical axis”. These descriptors are merely for clarity of the description and for differentiation of the various directions. These directional descriptors do not imply or require any particular orientation of the disclosed elements.

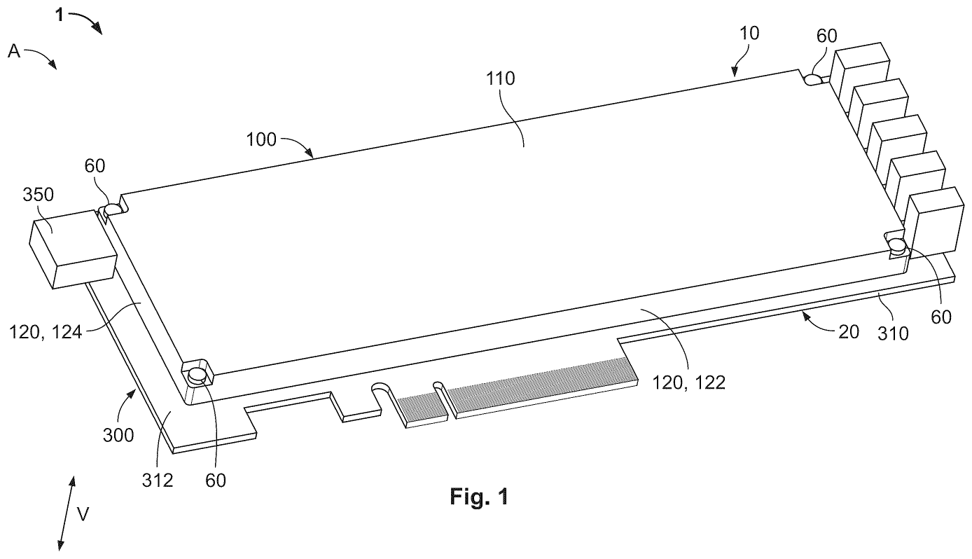

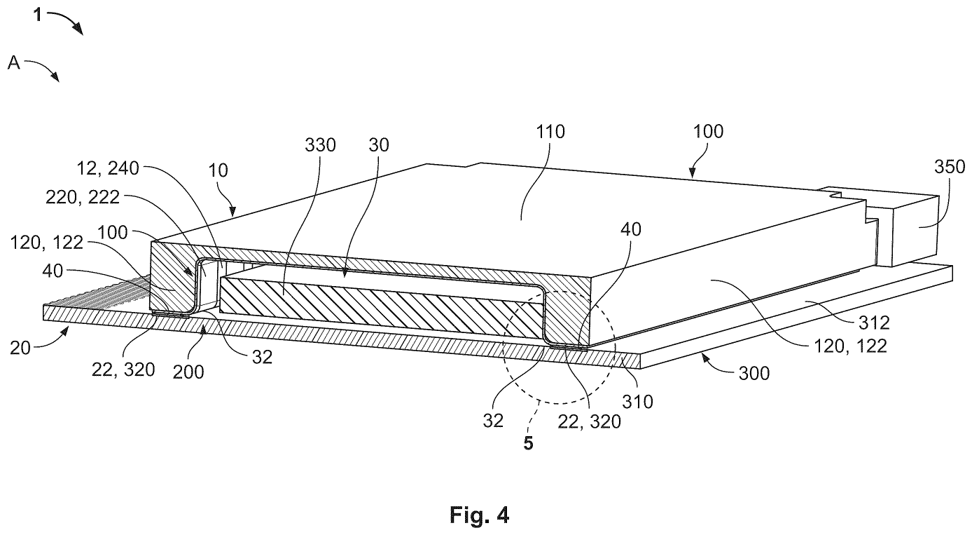

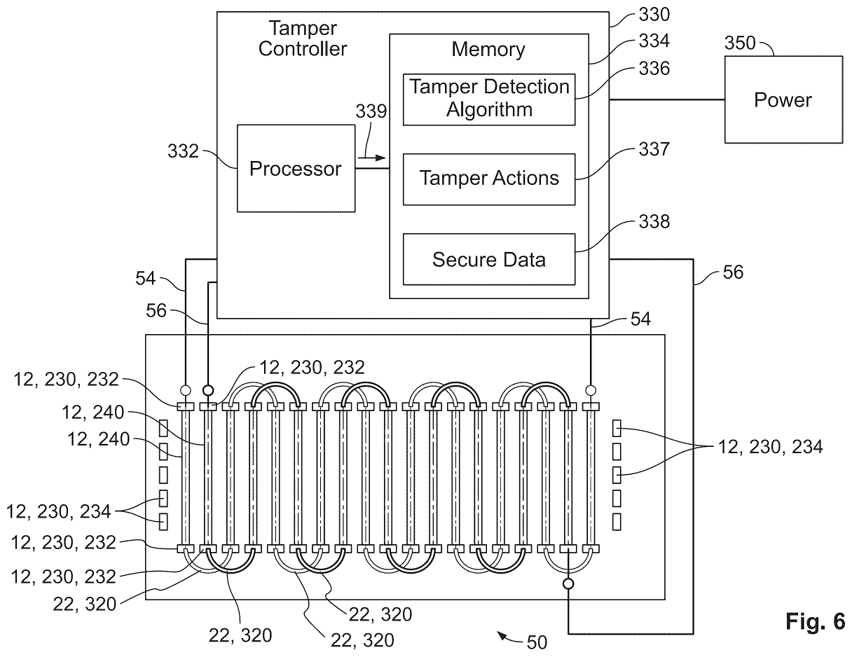

A tamper detection assembly 1, as shown in FIG. 1, includes a first body 10 and a second body 20 connected to the first body 10 in an assembled state A. The first body 10 and the second body 20 define and enclose a protective volume 30 in the assembled state A, as shown in FIG. 4. The first body 10 has a plurality of first electrical elements 12 and the second body 20 has a plurality of second electrical elements 22 that are electrically connected to the first electrical elements 12 in the assembled state A to form a tamper circuit 50, shown in FIGS. 4 and 6.

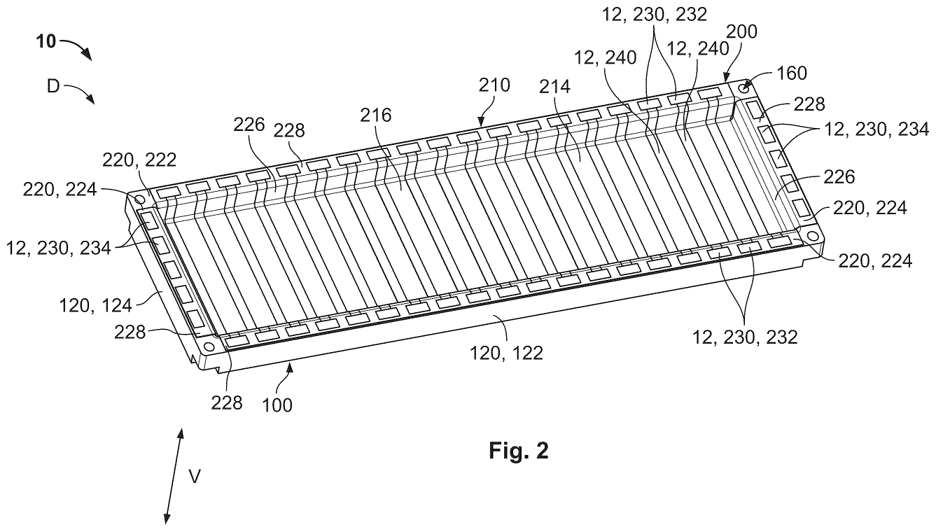

The tamper detection assembly 1 will be first described in detail with respect to a first embodiment shown in FIGS. 1-6. In the first embodiment, the first body 10 includes a housing 100 and a tamper detection sensor 200 disposed on the housing 100, as shown in FIG. 2. The second body 20 of the first embodiment includes a printed circuit board (PCB) 300.

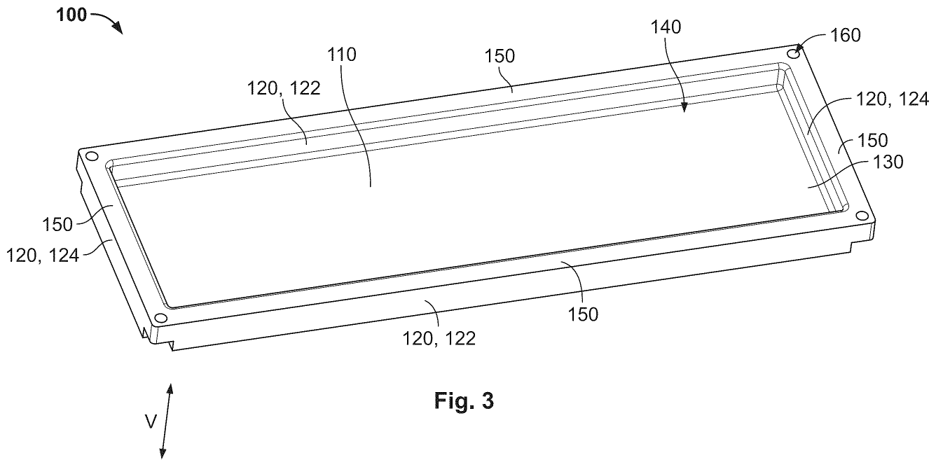

The housing 100, as shown in FIG. 3, has a base 110 and a plurality of side walls 120 extending from the base 110 along a vertical axis V. The housing 100 has an inner surface 130 extending along the base 110 and the side walls 120. The base 110 and the side walls 120 define a cavity 140 shown in FIG. 3. The housing 100 has a face 150 at an end of the side walls 120 opposite the base 110 along the vertical axis A; the face 150 is a surface that extends around a perimeter of the cavity 140. In the shown embodiment, the face 150 is parallel to the base 110.

In the embodiment shown in FIGS. 1-5, the housing 100 is an approximately rectangular element and the side walls 120 have a pair of first side walls 122 that form long sides opposite one another and a pair of second side walls 124 that form short sides opposite one another. In another embodiment, the side walls 120 of the housing 100 may define a square shape or any other shape that forms the cavity 140 and has the face 150 extending around the perimeter of the cavity 140.

The housing 100 has a plurality of fastening passageways 160 extending through the housing 100 along the vertical axis A. In the shown embodiment, the fastening passageways 160 are positioned on the face 150 at the corners of the housing 100. In other embodiments, the fastening passageways 160 may be formed in different numbers and be positioned differently on the housing 100.

The housing 100 is formed of a rigid material, such as an anodized aluminum. In the embodiment shown in FIG. 3, the housing 100 is monolithically formed in a single piece from the rigid material. In other embodiments, the housing 100 could be formed from a plurality of pieces assembled together.

The tamper detection sensor 200, as shown in FIG. 2, includes a tamper film 210 and a plurality of tamper contacts 230, 240 disposed on the tamper film 210.

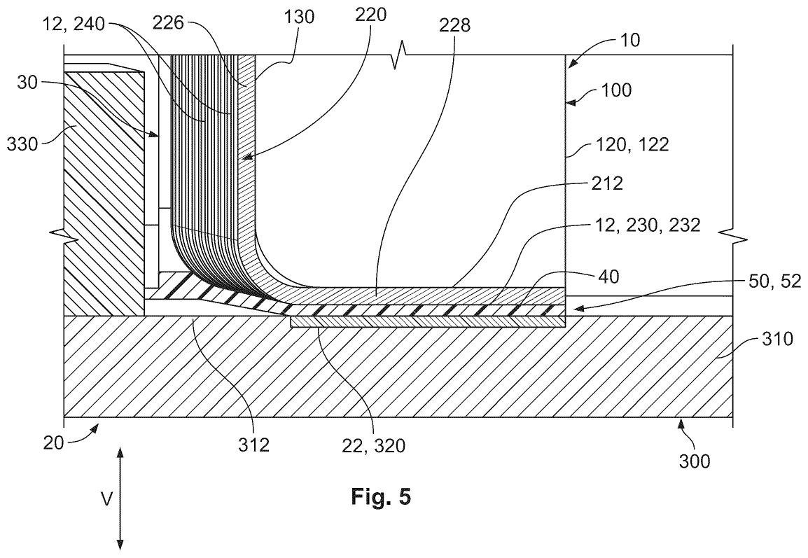

The tamper film 210 is formed of a flexible material, such as a polyvinylidene fluoride or a polyvinylidene difluoride (PVDF) film. The tamper film 210 has a first surface 212 and a second surface 214 opposite the first surface 212, as shown in FIGS. 2 and 5. As shown in FIG. 2, the tamper film 210 has a main body 216 and a plurality of legs 220 extending from the main body 216. In the shown embodiment, the legs 220 include a pair of first legs 222 opposite one another that form long sides of the tamper film 210 and a pair of second legs 224 opposite one another that form short sides of the tamper film 210.

The legs 220 are foldable with respect to the main body 216 due to the flexible material of the tamper film 210. The legs 220 each have a first portion 226 adjacent to and extending from the main body 216 and a second portion 228 extending from the first portion 226 to an end of the leg 220 opposite the main body 216. The first portion 226 and the second portion 228 are foldable with respect to each other and are foldable with respect to the main body 216.

As shown in FIG. 2, the tamper contacts 230, 240 are disposed on the tamper film 210 and are exposed on the second surface 214 of the tamper film 210. In the shown embodiment, the tamper contacts 230, 240 are a plurality of electrical traces embedded in or positioned on the tamper film 210; the tamper contacts 230, 240 may be formed of any conductive material that can be embedded in and/or positioned on the flexible material of the tamper film 210.

The tamper contacts 230, 240 include a plurality of pads 230 and a plurality of connection segments 240 that extend between some of the pads 230 in the shown embodiment. In the embodiment shown in FIG. 2, the pads 230 include a plurality of first pads 232 positioned on the second portion 228 of each of the first legs 222. The first pads 232 on one of the first legs 222 are each connected with the one of the first pads 232 on the other of the first legs 222 by one of the connection segments 240 that extends across the first portion 226 of each of the first legs 222 and across the main body 216 of the tamper film 210. The pads 230 include a plurality of second pads 234 positioned on the second legs 224 of the tamper film 210.

In the first embodiment, the first body 10 is formed by positioning the tamper detection sensor 200 in the housing 100. The tamper detection sensor 200 is foldable from a flat state into the folded state shown in FIG. 2. As shown in FIGS. 2, 4, and 5, the first surface 212 of the tamper film 210 is positioned against the inner surface 130 of the housing 100. The first surface 212 of the tamper film 210 can be attached to the inner surface 130 of the housing 100 by an adhesive.

The shape of the tamper detection sensor 200 corresponds to the shape of the housing 100; in the shown embodiment, the main body 216 has a rectangular shape and the first legs 222 are longer than the second legs 224 to correspond to the shape of the base 110 and the side walls 120 of the housing 100. In other embodiments in which the shape of the housing 100 is different than the rectangular shape, the shape of the tamper detection sensor 200 is likewise different and corresponds to the shape of the housing 100.

As shown in FIG. 2, the main body 216 of the tamper film 210 is positioned against the base 110, the first legs 222 are folded to extend along the first side walls 122, and the second legs 224 are folded to extend along the second side walls 124. The first portion 226 of each of the first legs 222 extends along one of the first side walls 122 and the second portion 228 of each of the first legs 222 is positioned on the face 150 adjacent to one of the first legs 222. Likewise, the first portion 226 of each of the second legs 224 extends along one of the second side walls 124 and the second portion 228 of each of the second legs 224 is positioned on the face 150 adjacent to one of the second legs 124. In the embodiment shown in FIG. 2, with the tamper detection sensor 200 positioned on the housing 100 to form the first body 10, the pads 230 of the tamper contacts 230, 240 are positioned on the face 150 and face outwards.

In the first embodiment shown in FIGS. 1-6, the PCB 300 is the second body 20. The PCB 300, as shown in FIGS. 1, 4, and 5, includes a substrate 310 and a plurality of board contacts 320 disposed on the substrate 310. The board contacts 320 are exposed on an upper surface 312 of the substrate 310. The board contacts 320 are connected to one another within the substrate 310 as described in greater detail below. The board contacts 320 may be formed of any type of conductive material that is used to form contacts or traces on the substrate 310 of the PCB 300. Although not all board contacts 320 are labeled for clarity of the drawings, the number of board contacts 320 on the PCB 300 corresponds to the number of pads 230 of the tamper contacts 230, 240 in the tamper detection sensor 200.

As shown in FIGS. 4-6, the PCB 300 has a tamper controller 330 positioned on the upper surface 312 of the substrate 310. The tamper controller 330, as shown in FIG. 6, includes a processor 332 and a memory 334 connected to the processor 332. The memory 334 is a non-transitory computer readable medium. The memory 334 has a tamper detection algorithm 336 stored thereon that, when executed by the processor 332, performs the tamper detection functions of the tamper controller 330 described herein. The memory 334 also has a plurality of tamper actions 337 stored thereon that can be executed by the processor 332 depending on the tamper detection performed by the tamper controller 330. In the shown embodiment, the memory 334 also has a plurality of secure data 338, such as encryption keys or other sensitive information, stored thereon. As shown in FIGS. 1, 4, and 6, the PCB 300 also has a power input 350 providing power to the tamper controller 330.

The assembly of the first body 10 and the second body 20 to form the tamper detection assembly 1 will now be described in greater detail.

In the first embodiment, the tamper contacts 230, 240 of the tamper detection sensor 200 are the first electrical elements 12 of the first body 10 and the board contacts 320 of the PCB 300 are the second electrical elements 22 of the second body 20. In a disassembled state D of the first body 10 shown in FIG. 2, although the first pads 232 on opposite first legs 222 are connected by the connection segments 240, adjacent pads 230 and connection segments 240 are at least partially isolated from one another on the tamper film 210 of the first body 10; the first electrical elements 12 are not capable of forming a continuous circuit in the disassembled state D. The board contacts 320 of the PCB 300 are likewise at least partially isolated from one another by the substrate 310 of the PCB 300; the second electrical elements 22 are not capable of forming a continuous circuit in the disassembled state D in which the PCB 300 or second body 20 is separated from the first body 10.

To assemble the first body 10 and the second body 20 to the assembled state A, as shown in FIGS. 4 and 5, the first body 10 is positioned on the second body 20 to enclose the protective volume 30 in the assembled state A. The tamper controller 330 is positioned in the protective volume 30. The face 50 of the housing 100 having the second portions 228 of the legs 220 disposed thereon is positioned facing the upper surface 312 of the substrate 310.

As shown in detail in FIG. 5, a conductive layer 40 is disposed between the second portions 228 of the legs 220 and the upper surface 312 of the substrate 310 in the assembled state A. The conductive layer 40, in various embodiments, may be a conductive epoxy, an anisotropic conductive film, which may only conduct in a Z-axis or along the vertical axis V in the shown embodiment, or may be any other conductive material that can be applied to and removed from the tamper detection sensor 200 and the PCB 300 without causing damage to either element, that also serves the conductive function of the conductive layer 40 described in detail herein.

The conductive layer 40 electrically connects the first electrical elements 12 and the second electrical elements 22 in the assembled state A. As shown in FIG. 5, the conductive layer 40 is positioned between the pads 230 of the tamper contacts 230, 240 and the board contacts 320 on the PCB 300 to form an electrical joint 52 of the tamper circuit 50 between the pads 230 and the board contacts 320. The electrical joint 52 shown in FIG. 5 is between one of the first pads 232 on one of the first legs 222 and one of the board contacts 320 but applies equally to all of the first pads 232 and second pads 234 on the legs 220 connecting to board contacts 320 on the PCB 300. The electrical joint 52 extends along an entirety of a perimeter 32 of the protective volume 30, shown in FIG. 4, and surrounds the protective volume 30.

As shown in FIG. 1, a plurality of connection elements 60 can be used to secure the first body 10 and the second body 20 in the assembled state A. The connection elements 60 provide a force that presses the first body 10 and the second body 20 together with the conductive layer 40 positioned between the first body 10 and the second body 20. In the shown embodiment, the connection elements 60 are screws that are positioned in the fastening passageways 160 of the housing 100 and mechanically connect the housing 100 of the first body 10 to the PCB 300 of the second body 20. In other embodiments, the connection elements 60 can be spring-loaded clamps or any other elements that are removable and can apply a constant pressure to secure the first body 10 to the second body 20.

Through the electrical joint 52 formed by the conductive layer 40 that connects the first electrical elements 12 and the second electrical elements 22, the tamper circuit 50 is completed. The tamper circuit 50 is continuous in the first body 10 and the second body 20 in the assembled state A. In an embodiment, the tamper circuit 50 is not able to be completed unless the electrical joint 52 is formed with the first body 10 and the second body 20 in the assembled state A.

In an embodiment, the tamper circuit 50 may form multiple continuous circuits in the first body 10 and the second body 20. As shown in the diagram of FIG. 6, a first circuit 54 and a second circuit 56 can be formed that each include some of the first electrical elements 12 and some of the second electrical elements 22. FIG. 6 shows a diagrammatic layout of the tamper contacts 230, 240 that serve as the first electrical elements 12. The board contacts 320 and traces within the substrate 310 that serve as the second electrical elements 22 and form a portion of the tamper circuit 50 in the PCB 300 are schematically indicated in FIG. 6.

As shown in FIG. 6, adjacent pads 230 and adjacent connection segments 240 are isolated from one another on separate circuits 54, 56. The first pads 232 and connection segments 240 forming the first circuit 54 alternate with first pads 232 and connection segments 240 forming the second circuit 56. Both circuits 54, 56 are only completed in the assembled state A via the electrical connection through the conductive layer 40. The circuits 54, 56, as shown in FIG. 6, are each connected to the tamper controller 330 and each provide a separate signal to the tamper controller 330. Although the second pads 234 are not shown connected to the circuits 54, 56 in the exemplary embodiment of FIG. 6, the second pads 234 could form additional circuits or could alternatively be connected to the first circuit 54 or the second circuit 56.

The circuits 54, 56 shown in FIG. 6 are merely an exemplary embodiment; in other embodiments, the tamper circuit 50 may include more than two circuits 54, 56 that are isolated from one another, only completed in the assembled state A, and each connected to the tamper controller 330.

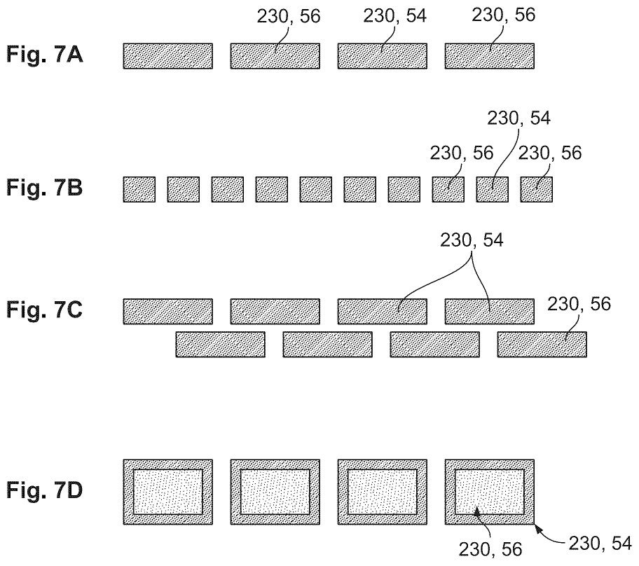

Arrangements of the pads 230 according to various embodiments are shown in FIGS. 7A-7D. FIG. 7A shows the embodiment of the pads 230 shown in FIGS. 2 and 6, a linear alternating arrangement of the pads 230 in different circuits 54, 56. In another embodiment shown in FIG. 7B, the pads 230 could have different shapes, for example a square shape instead of a rectangular shape, to increase the density of pads 230. In another embodiment shown in FIG. 7C, the pads 230 of the two circuits 54, 56 may be arranged in two rows overlapping one another and, in another embodiment shown in FIG. 7D, the pads 230 of the circuits 54, 56 could be arranged with the pads 230 of one circuit 54 positioned around the pads 230 of the other circuit 56. In various embodiments, the pads 230 can be positioned in any arrangement that creates a plurality of circuits of the tamper circuit 50 isolated from one another.

During use of the tamper detection assembly 1 in the assembled state A, in the embodiment shown in FIGS. 1-6, a voltage of each of the first circuit 54 and the second circuit 56 of the tamper circuit 50 is continually monitored by the tamper controller 330. The processor 332 executes the tamper detection algorithm 336 to monitor the voltages on each of the circuits 54, 56. If the tamper detection assembly 1 is tampered with and one of the circuits 54, 56 in the tamper circuit 50 is broken or interrupted, for example via separation of the first body 10 and second body 20 or physical intrusion by a drill, a laser, or other force, the tamper controller 330 detects the interruption and the processor 332 determines a tamper event 339 based on the change. In another embodiment, the tamper controller 330 compares the voltages of the circuits 54, 56 to one another and a tamper event 339 may be detected by the tamper controller 330 based on a threshold difference in the voltages. In other embodiments, the tamper controller 330 may monitor other measurable electrical quantities of the tamper circuit 50 and may have other changes in the measurable electrical quantities stored in the tamper detection algorithm 336 that trigger the tamper event 339.

The connection of the first electrical elements 12 and the second electrical elements 22 can form the tamper circuit 50 as a resistive circuit, as an inductive circuit, or as a capacitive circuit, with the relevant electrical quantity monitored by the tamper controller 330. In embodiments in which the tamper circuit 50 includes a plurality of circuits 54, 56, the tamper circuit 50 may include multiple of one type of resistive, inductive, or capacitive circuit, or may include more than one different type of circuit, such as one resistive circuit 54 and one inductive circuit 56. The tamper circuit 50, in various embodiments, includes at least one of a resistive circuit, an inductive circuit, and a capacitive circuit.

The processor 332 executes one of the tamper actions 337 based on the detection of the tamper event 339. In an embodiment, the tamper action 337 may be a wiping or complete erasing of the secure data 338 stored on the memory 334. In another embodiment, the tamper action 337 may be the activation of an alarm or alert. In various embodiments, the tamper actions 337 may be any actions chosen by a user to protect the secure data 338 stored on the memory 334.

A user of the tamper detection assembly 1 can disassemble the tamper detection assembly 1 from the assembled state A, for example to change the PCB 300 or other elements of the tamper detection assembly 1, or to service the elements of the tamper detection assembly 1. To disassemble the tamper detection assembly 1, the connection elements 60 are removed and the second body 20 is separated from the first body 10. When the second body 20 is separated from the first body 10 to the disassembled state D, the tamper circuit 50 is interrupted and the processor 332 executes one of the tamper actions 337.

The conductive layer 40 permits the separation of the first body 10 and the second body 20 without mechanical damage to either of the first body 10 or the second body 20. The first body 10 and the second body 20 are separable in whole from the assembled state A to the disassembled state D. Throughout the present specification, the phrase “separable in whole” is intended to mean that the bodies being separated are not physically damaged or destroyed in a manner that would render them unusable, but rather each remain as a whole part. The conductor layer 40 is also removable from the first body 10 and the second body 20 in the disassembled state D in a manner that does not damage the first body 10 or the second body 20. The tamper detection assembly 1 of the present embodiments thus allows for the elements of the tamper detection assembly 1 to be disassembled, serviced, replaced, and/or reused, which decreases waste and manufacturing costs and increases the useful life of the elements of the tamper detection assembly 1.

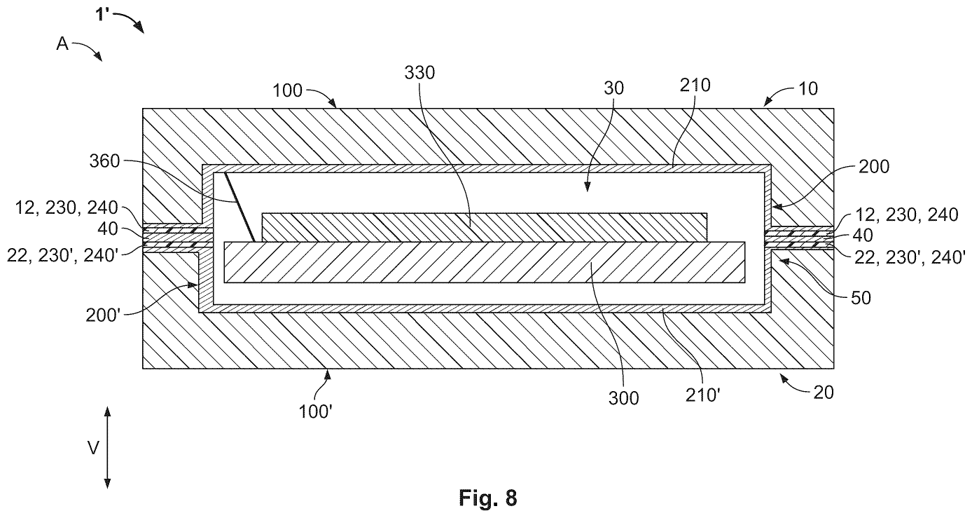

A tamper detection assembly 1′ according to another embodiment is shown schematically in FIG. 8. Like reference numbers refer to like elements and primarily the differences from the embodiment of the tamper detection sensor 1 of FIGS. 1-6 will be described in detail.

In the tamper detection assembly 1′ shown in FIG. 8, the first body 10 is the same as in the embodiment of FIGS. 1-6. The second body 20 of the tamper detection assembly 1′, instead of the PCB 300, is another housing 100′ and tamper detection sensor 200′. In the present embodiment, the housing 100 and the tamper detection sensor 200 of the first body 10 are referred to as a first housing 100 and a first tamper detection sensor 200, and the housing 100′ and the tamper detection sensor 200′ of the second body 20 are referred to as a second housing 100′ and a second tamper detection sensor 200′ positioned within the second housing 100′. In the shown embodiment, the second housing 100′ is formed identically to the first housing 100 and has all the same elements as the first housing 100 described in detail above, and the second tamper detection sensor 200′ is formed identically to the first tamper detection sensor 200 and has all the same elements as the first tamper detection sensor 200 described in detail above.

As shown in FIG. 8, in the tamper detection assembly 1′, the first housing 100 and the first tamper detection sensor 200 is positioned against the second housing 100′ and the second tamper detection sensor 200′ to enclose the protective volume 30. In this embodiment, the PCB 300 with the tamper controller 330 is positioned in the protective volume 30 but does not structurally define the protective volume 30.

In the tamper detection assembly 1′, the conductive layer 40 is positioned between the first tamper detection sensor 200 and the second tamper detection sensor 200'. The conductive layer 40 electrically connects the first electrical elements 12 formed as the first tamper contacts 230, 240 of the first tamper detection sensor 200 and the second electrical elements 22 formed as the second tamper contacts 230′, 240′ on the second tamper film 210′ of the second tamper detection sensor 200′ to form a tamper circuit 50 that is continuous in the first body 10 and the second body 20.

In the embodiment of FIG. 8, the tamper detection sensors 200, 200′ that are electrically connected to each other to form the tamper circuit 50 are connected to the PCB 300 by a lead 360 disposed in the protective volume 30. The tamper controller 330 monitors the tamper circuit 50 and executes tamper actions 337 as described above. The tamper detection assembly 1′ according to the embodiment of FIG. 8 can be disassembled without damage to the first body 10 or the second body 20 as described above; the first body 10 and the second body 20 of the tamper detection assembly 1′ are separable in whole.

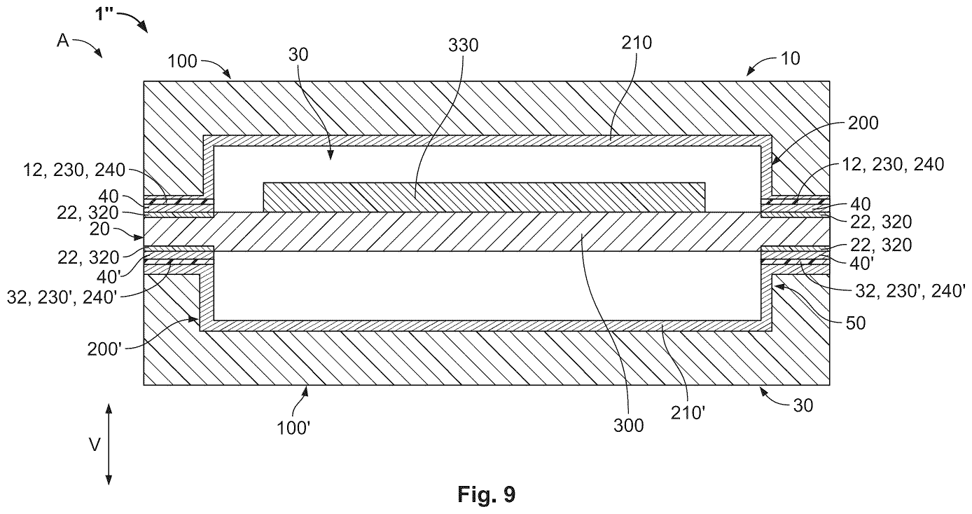

A tamper detection assembly 1″ according to another embodiment is shown schematically in FIG. 9. Like reference numbers refer to like elements and primarily the differences from the embodiments of the tamper detection sensor 1 of FIGS. 1-6 and the tamper detection assembly 1′ of FIG. 9 will be described in detail.

In the tamper detection assembly 1″ shown in FIG. 9, the first body 10 and the second body 20 are the same as in the embodiment of FIGS. 1-6. The tamper detection assembly 1″ further includes a third body 70 that has a plurality of third electrical elements 72. In the shown embodiment, the third body 70 is the second housing 100′ and the second tamper detection sensor 200′ positioned in the second housing 100′, which is positioned on a side of the PCB 300 opposite the first body 10 in the assembled state A. The third electrical elements 72 are the second tamper contacts 230′, 240′ on the second tamper film 210′ of the second tamper detection sensor 200′.

As shown in FIG. 9, one of the conductive layers 40 is positioned between one side of the PCB 300 and the tamper detection sensor 200 of the first body 10 and another of the conductive layers 40′ is positioned between another side of the PCB 300 and the tamper detection sensor 200′ of the third body 30. The conductive layers 40, 40′ electrically connect the first electrical elements 12 formed as the first tamper contacts 230, 240 of the first tamper detection sensor 200, the second electrical elements 22 formed as the board contacts 320 of the PCB 300, and the third electrical elements 72 formed as the second tamper contacts 230′, 240′ of the second tamper detection sensor 200′ to form the tamper circuit 50 that is continuous in the first body 10, the second body 20, and the third body 30 in the assembled state A. The tamper controller 330 monitors the tamper circuit 50 and executes tamper actions 337 as described above. The tamper detection assembly 1″ according to the embodiment of FIG. 9 can be disassembled without damage to the first body 10, the second body 20, or the third body 30 as described above; the first body 10, the second body 20, and the third body 30 of the tamper detection assembly 1″ are separable in whole.

1. A tamper detection assembly, comprising:
a first body having a plurality of first electrical elements; and
a second body having a plurality of second electrical elements, the first body and the second body are assembled to enclose a protective volume in an assembled state, the first electrical elements are electrically connected to the second electrical elements to form a tamper circuit that is continuous in the first body and the second body in the assembled state, the first body and the second body are separable in whole from the assembled state into a disassembled state in which the tamper circuit is interrupted.

2. The tamper detection assembly of claim 1, wherein the first electrical elements are isolated from one another on the first body and the second electrical elements are isolated from one another on the second body.

3. The tamper detection assembly of claim 1, further comprising a conductive layer disposed between the first body and the second body in the assembled state, the conductive layer electrically connects the first electrical elements and the second electrical elements.

4. The tamper detection assembly of claim 3, wherein the conductive layer is removable from the first body and the second body in the disassembled state.

5. The tamper detection assembly of claim 3, wherein the conductive layer forms an electrical joint of the tamper circuit between the first electrical elements and the second electrical elements in the assembled state, the electrical joint extends along a perimeter of the protective volume and surrounds the protective volume.

6. The tamper detection assembly of claim 1, further comprising a tamper controller positioned in the protective volume.

7. The tamper detection assembly of claim 6, wherein the tamper controller is connected to the tamper circuit, the tamper controller detects a tamper event when the tamper circuit is interrupted.

8. The tamper detection assembly of claim 7, wherein the tamper controller detects the tamper event based on a change in a measurable electrical quantity of the tamper circuit.

9. The tamper detection assembly of claim 7, wherein the tamper controller executes a tamper action when the tamper event is detected.

10. The tamper detection assembly of claim 1, wherein the tamper circuit includes a first circuit and a second circuit each including some of the first electrical elements and the second electrical elements, the first circuit and the second circuit are isolated from each other.

11. The tamper detection assembly of claim 1, wherein the tamper circuit includes at least one of a resistive circuit, an inductive circuit, and a capacitive circuit.

12. The tamper detection assembly of claim 1, further comprising a connection element connecting the first body and the second body and applying a force pressing the first body and the second body together in the assembled state, the connection element is removable to separate the first body and the second body into the disassembled state.

13. The tamper detection assembly of claim 1, wherein the first body includes a first housing and a first tamper detection sensor positioned within the first housing.

14. The tamper detection assembly of claim 13, wherein the first tamper detection sensor includes a first tamper film and a plurality of first tamper contacts disposed on the first tamper film, the first electrical elements are the first tamper contacts.

15. The tamper detection assembly of claim 14, wherein the second body is a printed circuit board, the second electrical elements are a plurality of board contacts on the printed circuit board.

16. The tamper detection assembly of claim 15, further comprising a conductive layer disposed between the first tamper film and the printed circuit board, the conductive layer electrically connects the first tamper contacts with the board contacts.

17. The tamper detection assembly of claim 14, wherein the second body includes a second housing and a second tamper detection sensor positioned within the second housing, the second tamper detection sensor includes a second tamper film and a plurality of second tamper contacts disposed on the second tamper film, the second electrical elements are the second tamper contacts.

18. The tamper detection assembly of claim 17, further comprising a conductive layer disposed between the first tamper detection sensor and the second tamper detection sensor, the conductive layer electrically connects the first tamper contacts and the second tamper contacts.

19. The tamper detection assembly of claim 16, further comprising a third body positioned on a side of the printed circuit board opposite the first body in the assembled state, the third body has a plurality of third electrical elements electrically connected to the first electrical elements and the second electrical elements to form the tamper circuit that is continuous in the first body, the second body, and the third body in the assembled state.

20. The tamper detection assembly of claim 19, wherein the third body includes a second housing and a second tamper detection sensor positioned within the second housing, the second tamper detection sensor includes a second tamper film and a plurality of second tamper contacts disposed on the second tamper film, the second tamper contacts are the third electrical elements.
